(19) United States
(12) Patent Application Publication
(10) Pub. No.: US 2008/0189147 A1
(43) Pub. Date: Aug. 7, 2008

(54) Methods and systems for sharing season tickets with multiple owners and managing season tickets over a communication network

(76) Inventor: Daniel H. Bartlett, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/701,706

(22) Filed: Feb. 2, 2007

(51) Int. Cl. G06Q 90/00

(52) U.S. Cl. 705/6

(57) ABSTRACT

A system, computer software product and a method for sharing season tickets with multiple owners and managing an individual's season tickets. A server and website manage a group of season ticket owners for the purpose of sharing season tickets. The website has interactive menus and “wizards” that allow individual owners to enter their preferences of games or events and then to rank the games or events in order of importance to them. The website provides an automated drafting system that selects games or events on behalf of individual owners based on their entered preferences and rankings. The website also provides a “live draft” option where an individual owner can actually select individual games or events during the draft. In the case of the “live draft” the website is capable of providing recommendations to the individual user based on the preferences and rankings entered by the user. The website delivers results of the draft to everyone in the group and allows options to trade, sell, assign, or buy tickets within the ownership group. The system and website also facilitates and encourages the use of electronic tickets as ticket owners will become accustomed to managing their tickets virtually on the website. The server provides an email/message board for communication amongst the group. The software provides open Application Programming Interfaces, or APIs, for the purpose of allowing owners to communicate, interact directly, and conduct transactions with the season ticket sellers (for example a professional sports team, a theatre company, or any other business that sells season tickets as well as service enterprises or businesses that provide ticker services for the previous entities in this list) as well as with ticket vendors or the marketplace to sell tickets to the general public. Also provided is a marketplace for ownership interests in season tickets.

### CROSS-REFERENCE TO COMPUTER PROGRAM LISTING APPENDIX

Appendix A contains the following files in one CD-ROM (of which two identical copies are attached hereto), and is a part of the present disclosure and is incorporated by reference herein in its entirety.

Document Description: Index of text files contained on two identical replacement compact disks submitted on Sep. 7, 2007 (which text files are the same as the text files on the original compact disks submitted on Feb. 2, 2007). All files on these two replacement compact disks are source code documents used to implement the invention. All files are readable using a text editor such as Microsoft Notepad.

Volume Serial Number is 1496-98B8

Directory: Code Dump—Jan. 27, 2007 This Directory contains the files that make up the software to implement the invention as of the filing date. The software is in the Java 5/J2EE programming language.

```
“Directory: sstickets”
  “Directory: sstickets-business”
    “File: .classpath, 1 KB, 1/29/2007”
    “File: .project, 1 KB, 1/29/2007”
    “Directory: .settings”
      “File: org.eclipse.jdt.core.prefs, 1 KB, 1/29/2007”
    “File: build.properties, 2 KB, 1/29/2007”
    “File: build.xml, 3 KB, 1/29/2007”
    “Directory: classes”
      “File: hibernate.properties, 1 KB, 1/29/2007”
    “Directory: src”
      Directory: com
        Directory: sstickets
          Directory: business
            Directory: account
              File: Account.java 2 KB 1/29/2007
              File: AccountDTO.java 2 KB 1/29/2007
              File: AccountService.java 1 KB 1/29/2007
              File: AccountServiceLocalImpl.java 1 KB 1/29/2007
          Directory: framework
            Directory: business
              File: AbstractBusinessObject.java 1 KB 1/29/2007
              File: AbstractService.java 1 KB 1/29/2007
              File: Service.java 1 KB 1/29/2007
              File: ServiceLocator.java 1 KB 1/29/2007
            Directory: persistent
              File: AbstractDAO.java 1 KB 1/29/2007
              File: AbstractVO.java 1 KB 1/29/2007
              Directory: hibernate
                File: HibernateUtil.java 1 KB 1/29/2007
          Directory: persistent
            Directory: account
              File: AccountDAO.java 1 KB 1/29/2007
              File: AccountVO.java 2 KB 1/29/2007
            Directory: draft
              Directory: rules
                File: DraftRuleDetailOptionVO.java 2 KB 1/29/2007
                File: DraftRuleDetailVO.java 2 KB 1/29/2007
                File: DraftRuleVO.java 2 KB 1/29/2007
            Directory: season
              File: EventAttributeOptionVO.java 2 KB 1/29/2007
              File: EventAttributeVO.java 2 KB 1/29/2007
              File: EventAttributeValueVO.java 2 KB 1/29/2007
              File: EventVO.java 1 KB 1/29/2007
              File: GenreVO.java 1 KB 1/29/2007
              File: SeasonVO.java 2 KB 1/29/2007
            Directory: tenant
              File: TenantVO.java 2 KB 1/29/2007
        File: hibernate.properties 1 KB 1/29/2007
      “Directory: sstickets-web”
        “File: .classpath 2 KB, 1/29/2007”
        “Directory: .externalToolBuilders”
          “File: Build sstickets-web.launch, KB, 1/29/2007”
        “File: .project, 1 KB, 1/29/2007”
        “File: build.properties, 2 KB, 1/29/2007”
        “File: build.xml, 3 KB, 1/29/2007”
        “Directory: src”
          Fil 1 KB, 1/29/2007”
          “Directory: com”
            “Directory: sstickets”
              “Directory: framework”
                “Directory: web”
                  “Directory: struts”
                    “File: AbstractAction.java, 2 KB, 1/29/2007”
                    “File: AbstractActionForm.java,
                    1 KB, 1/29/2007”
                    “File: RequestNoCache.java, 2 KB, 1/29/2007”
                    “File: chain-config.xml, 8 KB, 1/29/2007”
              “Directory: web”
                “Directory: account”
                  “File: LoginAction.java, 1 KB, 1/29/2007”
                  “File: LoginForm.java, 1 KB, 1/29/2007”
                  “File: MyAccountAction.java, 2 KB, 1/29/2007”
                  “File: MyAccountForm.java, 1 KB, 1/29/2007”
                  “File: SignUpAction.java, 2 KB, 1/29/2007”
                  “File: SignUpForm.java, 2 KB, 1/29/2007”
                “Directory: home”
                  “File: HomeAction.java, 1 KB, 1/29/2007”
                  “File: HomeForm.java, 1 KB, 1/29/2007”
                  “File: FieldValidators.java, 2 KB, 1/29/2007”
                  “File: validator-rules.xml, 1 KB, 1/29/2007”
                “Directory: validators”
        “Directory:war”
      “Directory: WEB-INF”
        “Directory: classes”
          “File: MessageResources.properties, 1 KB, 1/29/2007”
          “Directory: com”
            “Directory: sstickets”
              “Directory: framework”
                “Directory: web”
                  “Directory: struts”
                    “File: chain-config.xml, 8 KB, 1/29/2007”
              “Directory: web”
                “Directory: account”
                “Directory: home”
                “Directory: validators”
                  “File: validator-rules.xml, 1 KB, 1/29/2007”
    “File: faces-config.xml, 2 KB, 1/29/2007”
    “File: jboss-web.xml, 1 KB, 1/29/2007”
    “Directory: lib”
    “File: struts-config.xml, 4 KB, 1/29/2007”
    “File: tiles-defs.xml, 1 KB, 1/29/2007”
    “File: validation.xml, 1 KB, 1/29/2007”
    “File: web.xml, 3 KB, 1/29/2007”
  “Directory: account”
    “File: login.jsp, 1 KB, 1/29/2007”
    “File: myAccountView.jsp, 1 KB, 1/29/2007”
    “File: signUp.jsp, 2 KB, 1/29/2007”
    “File: signUpSuccess.jsp, 1 KB, 1/29/2007”
  “Directory: error”
    “File: default.jsp, 1 KB, 1/29/2007”
  “Directory: home”
    “File: home.jsp, 1 KB, 1/29/2007”
  “File: index.jsp, 1 KB, 1/29/2007”
  “Directory: layout”
    “File: layout.jsp, 1 KB, 1/29/2007”
Directory: First Ticket Sharing Software,
```

This Directory contains the files used to create the initial version of the software prior to the filing date of this invention. These files are in the PHP programming language.

“File: db.php, 1 KB, 1/29/2007”
“File: db_ticket.php, 11 KB, 1/29/2007”
“File: draft.php, 8 KB, 1/29/2007”
“File: draft_results.php, 2 KB, 1/29/2007”
“File: draft_transcript.php, 1 KB, 1/29/2007”
“File: output_global.php, 13 KB, 1/29/2007”
“File: output_ticket.php, 14 KB, 1/29/2007”
“File: owner_ranking.php, 1 KB, 1/29/2007”
“File: readme.php, 2 KB, 1/29/2007”
“File: view_season.php, 1 KB, 1/29/2007”

Directory: splitseasontickets The files in this directory contain the software and resources needed to produce the visual appearance of the invention in its initial form. The software and resources in this directory are combined with the files in the “Code Dump” directory to create an implementation of the invention.

```
“Directory: css”
    “File: main.20061217.css, 6 KB, 12/17/2006”
    “File: main.4.css, 7 KB, 12/15/2006”
    “File: main.css, 3 KB, 12/18/2006”
    “File: manual_rank.css, 2 KB, 12/18/2006”
“Directory: functions”
    “File: output_global.php, 5 KB, 12/18/2006”
“Directory: javascript”
    “File: coordinates.js, 3 KB, 11/22/2006”
    “File: drag.js, 8 KB, 11/22/2006”
    “File: dragdrop.js, 9 KB, 11/22/2006”
    “File: effects.js, 34 KB, 12/9/2006”
    “File: navigation.js, 3 KB, 12/9/2006”
    “File: prototype.js, 56 KB, 12/9/2006”
“Directory: myaccount”
    “File: MANUALRANK-SAVE.php, 11 KB, 12/18/2006”
    “File: activity_log.php, 98 KB, 12/18/2006”
    “File: draft.php, 8 KB, 12/18/2006”
    “File: draft_results.php, 13 KB, 1/18/2007”
    “File: form-receive.php, 1 KB, 12/15/2006”
    “File: index.php, 1 KB, 12/17/2006”
    “File: main.css, 3 KB, 12/18/2006
    “File: overview.php, 5 KB, 12/18/2006”
    “File: rank.php, 6 KB, 12/18/2006”
    “File: rank2.php, 3 KB, 12/18/2006”
    “File: rank3.dec18.php, 11 KB, 12/18/2006”
    “File: rank3.php, 11 KB, 12/18/2006”
    “File: rank4.php, 4 KB, 12/18/2006”
    “File: rank5.php, 6 KB, 12/18/2006”
    “File: tabletest.html, 2 KB, 12/18/2006”
“Directory: products”
    “File: index.php, 1 KB, 12/9/2006”
    “File: seasontickets.php, 1 KB, 12/8/2006”
“Directory: prototype3”
    “File: main.css, 3 KB, 12/17/2006”
    “File: test5.html, 2 KB, 12/17/2006”
“Directory: seasontickets”
    “File: index.php, 1 KB, 12/19/2006”
    “File: mlb.php, 3 KB, 12/19/2006”
    “File: mls.php, 1 KB, 12/19/2006”
    “File: nba.php, 1 KB, 12/19/2006”
    “File: nfl.php, 1 KB, 12/19/2006”
    “File: nhl.php, 1 KB, 12/19/2006”
    “File: other.php, 1 KB, 12/19/2006”
“Directory: test”
    “File: chrome.js, 7 KB, 12/11/2006”
    “File: chromestyle.css, 2 KB, 12/11/2006”
    “File: dropdown.css, 5 KB, 12/11/2006”
    “File: dropdown.js, 1 KB, 12/11/2006”
    “File: menutest.html, 7 KB, 12/11/2006”
    “File: test2.html, 3 KB, 12/11/2006”
    “File: test3.html, 3 KB, 12/11/2006”
```

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to the computer-based ordering of goods and/or services over a communication network and in particular to the ordering of goods and/or services related to season tickets and individual tickets for sports events and entertainment events, for example, and in one aspect to the allocation of season tickets among multiple users.

### BACKGROUND OF THE INVENTION

It is well known for individuals to purchase, trade, and/or exchange tickets for individual games or events using a communication network such as the Internet. Such exchanges can happen between individuals and the sports and entertainment business, between an individual and a ticket broker, or between two individuals using an online marketplace or an internet posting service.

A problem with such prior art systems that handle ticket exchanges is that the end consumers who purchase season tickets, in other words, consumers who purchase tickets for more than one game or event at a time, do not have adequate tools to manage their lot of tickets. Existing ticket exchange systems focus on buying and selling tickets for individual games or events.

Purchasers of season tickets have tickets for multiple games or events. These purchasers of season tickets presently do not have an adequate system for managing their set of tickets to multiple games or events. Further, owners who share season tickets do not have adequate tools to manage the sharing and distribution process that must occur before and during every season.

Season tickets are often purchased by a group comprised of two or more owners. Typically season ticket owners share, or “split”, season tickets for one or more of the following reasons: (1) to reduce the cost to each owner as they could not or do not choose to purchase an entire season of tickets, (2) to allow owners to attend only a certain number of games or events that they want to attend and not ALL games or events, and/or (3) to allow businesses or companies that own season tickets to divide the games or events amongst various people in their respective organizations. In addition, there is no known available mechanism for individuals not previously known to each other to come together to purchase season tickets as a group. It is reasonable to assume that sports and entertainment enterprises could sell more season tickets if there were available a mechanism for strangers to come together in a trusted system to purchase portions of season tickets.

Groups of people jointly purchasing season tickets must have a way to divide the set or sets of tickets. Typically the owners meet in some capacity to select a draft time and date and a drafting order. Then at a later date the owners must again meet to select games or events in turn one after the other following the agreed upon rules and drafting order. This process is often time consuming as each owner must: (1) determine which games are most desirable to that owner; (2) agree with the other owners upon a time and place to meet to draft the games or events; and (3) sit through the actual drafting process. Finally the group must distribute the actual tickets. Additional tasks that are needed by the owners of the tickets after the draft is complete, such as trading, selling, buying, or assigning tickets, must be handled separately by each individual owner.

Accordingly, it is desirable to allow groups of owners (whether people or companies or combinations thereof, for example) to divide up their season tickets in a manner that takes into account the preferences of each owner. It is further desirable to develop computer-based systems that allow such groups of owners to divide up their season tickets in a relatively quick, efficient manner.

### SUMMARY OF THE INVENTION

The present invention is directed to an improved system, method and software application that overcomes many of the deficiencies of the prior art.

In accordance with aspects of the present invention there are provided systems and methods for ordering goods and/or services with respect to season tickets over a communication network, comprising providing a website, server and a database that:

(a) allow one or more season ticket owners to select and purchase a service for a season for which they own season tickets. The service will allow the purchasers to manage their tickets for a given season using the provided server and website. The purchasers shall have the option of adding to the service one or more additional owners who belong to the group of season ticket owners;

(b) allow the one or more season ticket owners who have purchased the service to add additional owners to the service, set the preferences for the group (such as group name, draft date, group preferences, draft order) and notify and communicate with all members of the group using an email and internet posting function provided by the service;

(c) allow season ticket owners to view all of their options for a given season, enter a set of preferences related to the characteristics of the games or events in a season and then allows the season ticket owners to rank those preferences;

(d) take the preference input and preference rankings from the season ticket owners and, using a weighted system of points based on the season ticket owners' inputs, generates a ranked list of games or events;

(e) allow the season ticket owner to view the ranked list of games or events generated by the system, and then fine-tune that ranking by “dragging-and-dropping” individual games or events to allow the season ticket owners to get the precise game or event rankings they desire;

(f) allow each season ticket owner to enter preferences regarding consecutive games or events because some owners may find consecutive games or events desirable, while others may not desire or care about consecutive games or events. In addition, each season ticket owner will have the option to mark specific consecutive games or events or subsets of consecutive games or events that the season ticket owner would accept being drafted. The system will allow season ticket owners to fine tune their preferences in this regard so that the drafting engine provided by the system will more accurately select their games or events;

(g) allow the season ticket owner to set a time for the drafting of games or tickets by the group, and then also gives each individual season ticket owner the option of attending a “live draft” via his/her/its personal computer or other device connected to a communication network, such as the internet, or allowing the system to select games or events for each owner using each owner's preference and ranking input;

(h) allow season ticket owners to attend a live draft where any member of the group of season ticket owners can view the draft in real time and the system will request a selection from an owner every time it is that owner's turn to select a game or event. The preference and ranking information entered by that owner will serve as a recommendation list from which the system will dynamically recommend games or events to that owner at every turn. Games or events selected by other owners will automatically be removed from that owner's recommendation list and games that are consecutive to games already selected by that owner will be highlighted;

(i) allow each season ticket owner to decide to let the system draft his, her or its games or events for him, her or it by using all of the preference and ranking information entered by the season ticker owner. In this case, a season ticket owner would not be required to attend the “live draft”, and the system would make the selection for each season ticket owner at his, her or its turn in the draft. Note that a season ticket holder can be male, female or an entity such as a company or a partnership, for example. For simplicity hereinafter the pronouns “his”, “he” or “him” will be used with the understanding that these pronouns represent all possible types of owners (male, female or an entity such as a company or partnership) of season tickets;

(j) will email to the owners the results of the draft upon completion of the draft and create a results page on the website so that the results for the entire group of owners in addition to individual results are available to all of the owners in the group. In addition, an activity log, which will document every action taken by the group and the system, will be provided and will be accessible to all season ticket owners in the group;

(k) allow season ticket owners to trade, sell, buy, or assign their tickets to other owners within the group once the draft is complete. If there is only one owner of the season's ticket or tickets and therefore no draft, the assign option is available with respect to owners in other groups upon purchase of the service by the one owner;

Embodiments of the invention also provide application programming interfaces, (“APIs”), that:

(1) will allow the software system to interact, exchange data, and conduct transactions with the actual ticket sellers (for example, an amateur or professional sports team, an entertainment business such as a musical group or a theater group, any other enterprise that provides users with tickets to sequential events, or an enterprise or business that provides ticket services for any of the aforementioned entities);

(m) will allow the system of the present invention to become integrated into the systems of the actual ticket sellers upon mutual consent. This will benefit the season ticket owners by allowing accurate data regarding their games or events and tickets to be loaded directly from the ticket sellers. Further, it will allow the ticket sellers to provide superior service to their season ticket owners in terms of ticket fulfillment (physical or electronic), and it will provide the ticket sellers with enhanced marketing information and further cross selling and marketing opportunities. Lastly, ticket sellers can allow the purchase, sale, trade, and re-sale of tickets in the seller system by connecting to the system of the present invention via the APIs; and

(n) will allow the software system used by a group of owners of one or more season tickets to interact and exchange data with ticket brokers. Additionally, the APIs and software architecture will allow the system of the present invention to become integrated in the systems of the ticket brokers upon mutual consent. This will allow a group of season ticket owners to sell unwanted tickets quickly and easily to people outside of the group;

Embodiments of this invention also provide:

(o) a server, website, and database that will keep track of season ticket owners actions and remind season ticket owners of upcoming seasons and news and data relevant to their preferences and past actions; and

(p) a server and website that creates a marketplace for ownership shares of season tickets.

These and other aspects, objects, features, and advantages of the present invention will be more clearly understood and appreciated from a review of the following detailed description of embodiments of the invention taken in conjunction with the accompanying drawings.

### BRIEF DESCRIPTION OF THE DRAWINGS

FIG. 1 illustrates a system made in accordance with the present invention;

FIGS. 2a-2f illustrate flow charts of the operations of the system of FIG. 1 in accordance with the present invention;

FIGS. 3a-h illustrates screen displays of management, preference, ranking, drafting, and results in accordance with the present invention.

### DETAILED DESCRIPTION OF THE INVENTION

The following description is meant to be illustrative only and not limiting. Other embodiments of this invention will be obvious to those skilled in the art in view of this description.

As a general matter, the invention relates to a system and method for allowing a group of users to divide one or more sets of season tickets among themselves. Each user enters a set of preferences, which describes each user's preferences for certain tickets over others. These preferences are then used to calculate a ranked list of games or events that is specific to each user. These ranked lists can then be used in either an automated draft, or a live draft to assign tickets to each owner in the group. In the automated draft, games or events are automatically selected for each user by the system according to each user's ranked list. In the live draft, users can take turns picking games or events from the pool of available games or events, with or without their individual ranked list used as a guide. The system can also allow users to conduct transactions involving their games or events after the draft.

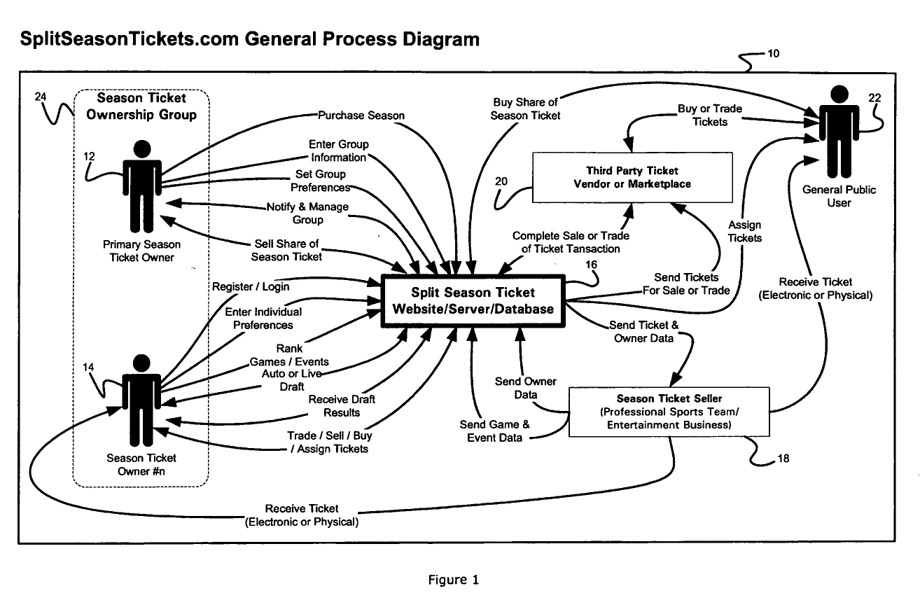

Referring to FIG. 1 there is illustrated a schematic diagram 10 showing the relationship between the system 16 in accordance with the present invention and the various entities with which system 16 interacts. In particular, the schematic diagram 10 shows a primary season ticket owner 12 (hereinafter “PST owner 12”) having an appropriate communication device for communicating over a communications network such as the internet. PST owner 12 communicates with the split-season-ticket website/server/System 16 (hereinafter “System 16”) over a communication network such as the internet.

PST owner 12 selects and purchases a service (such as managing the distribution of one or more tickets among the owners 12 and 14 of the one or more season tickets owned by the group 24) from the System 16. Additionally, the service may be purchased for PST owner 12 by a season ticket seller 18 or a third party vendor or marketplace 20, as those entities will find it beneficial for many reasons to have their PST owner 12 and season ticket owner 14 use this service. System 16 authorizes payment (from PST owner 12, season ticket seller 18 or third party vendor or marketplace 20) and creates a group website for PST owner 12 and creates all necessary data tables to enable PST owner 12 to manage season tickets for his/her personal use and for the remaining n-1 season ticket owners 14 belonging to the season ticket ownership group 24 where. “n” is an integer representing the total number of season ticket owners in the group 24.

PST owner 12 accesses the System 16 and enters/edits:

(1) all of the general information with respect to group 24, such as name of group 24, draft order and draft date;

(2) any and all preferences of group 24, such as selection method of draft order, games or events with special characteristics, as well as rules surrounding trading tickets within the group 24; and

(3) contact information (including email address or another primary address for contacting each member of group 24 such as mobile phone number or instant messenger ID) for PST owner 12 and all season ticket owners 14 in the season ticket ownership group 24.

Upon direction from the PST owner 12, System 16 sends an email notification (or other equivalent electronic notification such as a text message or an instant message) to all of the season ticket owners 14 in the season ticket ownership group 24. This email notification (or equivalent) contains a description of the service to be provided by System 16, and detailed instructions on how to access the service. PST owner 12 has administration tools through System 16 for the ongoing management of all affairs related to the season ticket ownership group 24. In addition, PST owner 12 has the ability to offer for sale a percentage ownership sale of the season ticket ownership group 24. Any sale of ownership must have consent of the season ticket owners 14 belonging to the season ticket ownership group 24 or the owner 14, according to the contractual obligations agreed to by the members of group 24.

Upon receiving email (or equivalent) notification from the System 16, each season ticket owner 14 shall, individually at a time of his choosing, access the System 16 and register, login, and begin the process of ranking their games or events for the season. At this point, PST owner 12 becomes a season ticket owner 14 and follows the same process as other owners in group 24.

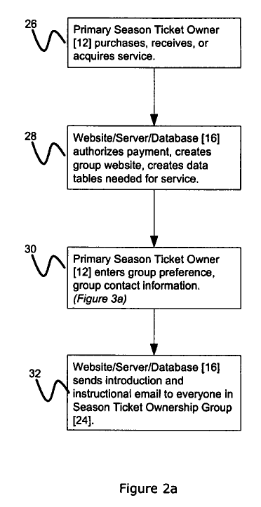

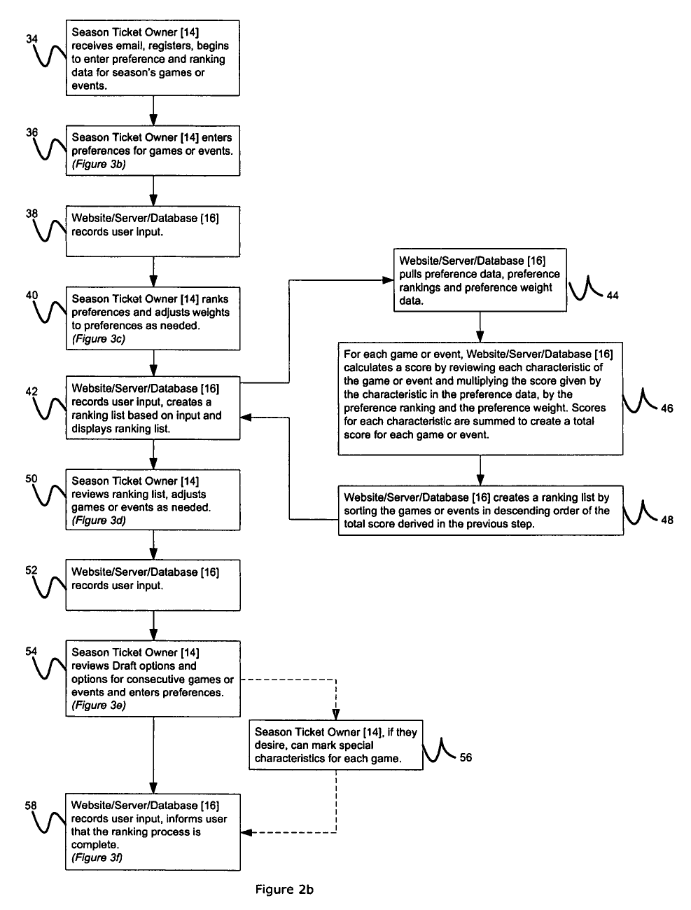

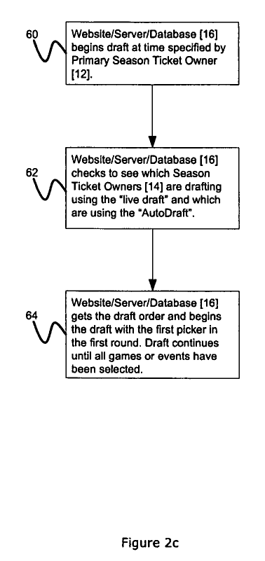

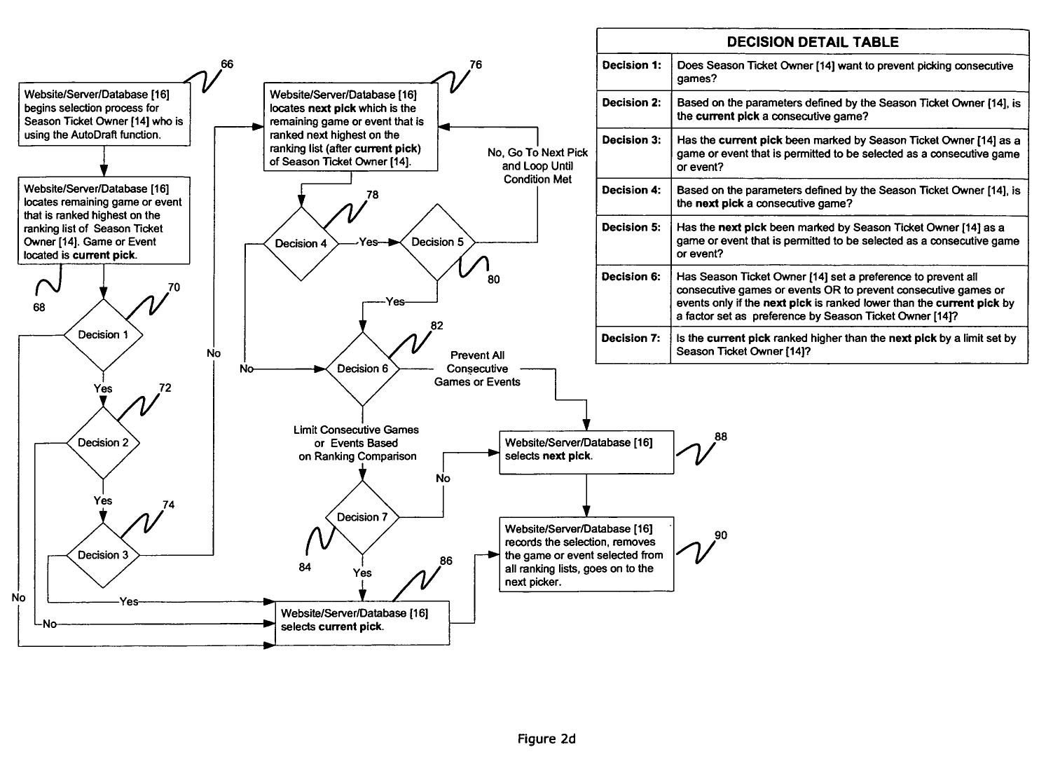

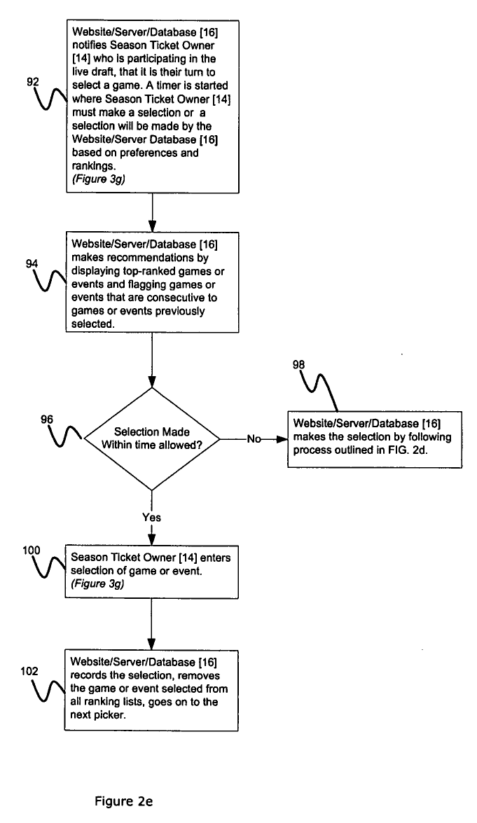

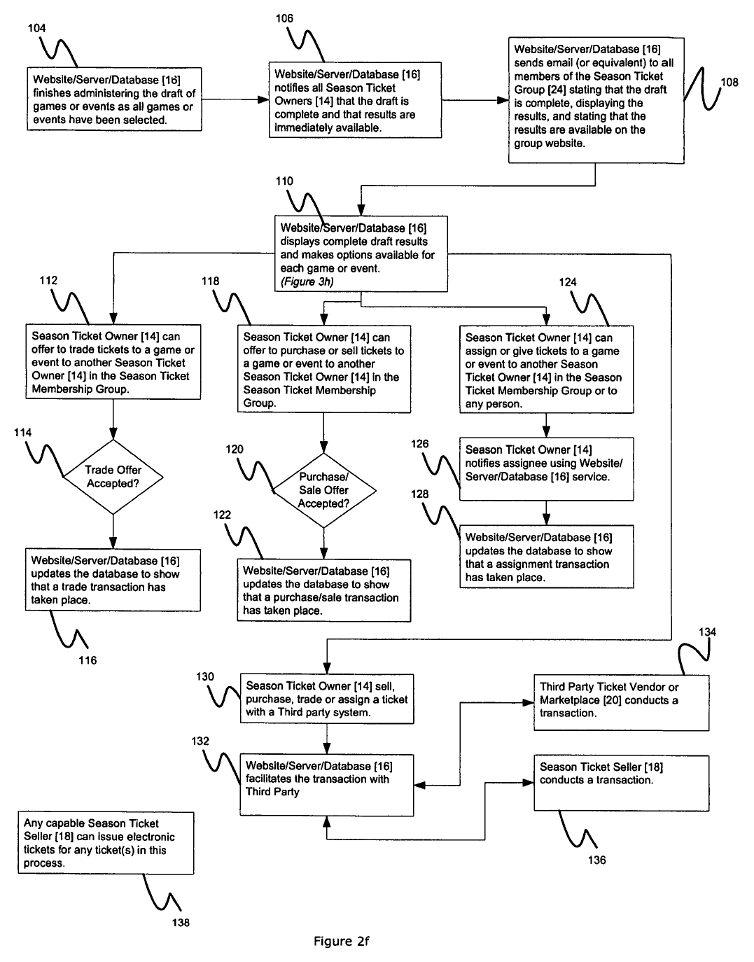

FIG. 2a shows a high level flow diagram of the process implemented and disclosed with this invention.

Block 26 shows the PST owner 12 purchasing, receiving or acquiring the split-season-ticket service in accordance with this invention.

Block 28 shows that the System 16 associated with the split-season-ticket service authorizes the payment by either the PST owner 12 using for example a credit card or some other mechanism or by each of the owners 14 in the season ticket ownership group 24 made up of primary season ticket owner 12 and season ticket owners 14. The System 16 also creates a group web-site for the season ticket ownership group 24 and creates the data tables (to be described below) needed for this group in order to allocate the tickets being purchased by this group to the members 12 and 14 of this group.

The primary season ticket owner 12 (FIG. 1) enters into System 16 the group preference information (block 30) as well as the contact information for each of the owners 12 and 14 of the group 24. Hereinafter when group 24 is referenced in conjunction with the draft implemented by the split-season-ticket System 16 of this invention, a reference to season ticket owner or owners 14 of this invention shall also include, if the context requires, the primary season ticket owner 12.

System 16 as shown in block 32 then sends an introduction email to the members of the season ticket ownership group 24 as well as an instructional email to these members.

FIG. 2b illustrates in more detail the procedure implemented in accordance with this invention.

As shown in block 34, season ticket owner 14 receives an email from System 16, and in response thereto registers by providing to System 16 the owner's email address and such other information as may be required by System 16. For example, owner 14 can be required to provide a credit card for use by the entity offering the season ticket or additional personal information and personal preferences such as age, sitting preference, any physical imparities and information required to comply with the America Disability Act (ADA), for example. In addition, preferences related to games or events such as preferred opponent(s) or parking preferences can be set forth as well as contact information such as address, telephone numbers, fax numbers and email addresses.

Owner 14 will also enter preferences from a list of preferences provided by System 16 to each owner and will enter ranking data for the season's games or events. The ranking data reflects the games or events which the owner 14 would like to see in sequential order of preference.

Block 36 shows that the season ticket owner 14 (FIG. 1) has entered preferences for games or events. Owner 14 prioritizes preferences within preference categories. These preference categories might include, for example, preferred dates, months, times, performers or teams, any special promotional give-aways, and locations.

Block 38 then shows that System 16 records the user's preferences for games or events.

Block 40 shows that the System 16 displays the categories of preferences and requests the owner 14 to “weigh” each preference category. The owner 14 weighs each preference category by selecting a value in a range that begins with “Most Important” and ends with “Not Important”. By giving each preference category a weight in this manner, owner 14 can prioritize the preference categories.

Block 42 then has the database recording the user input as to preferences and the weights associated with the preference categories. System 16 then creates a ranking list based on input and displays this ranking list. The system then has a loop which in block 44 causes the System 16 to analyze the preference data and the preference category weight data. Then as shown in block 46, for each game or event, System 16 calculates a score by reviewing each characteristic of the game or event and multiplying the score given by the characteristic in the preference data by the preference ranking and the preference weight. Scores for each characteristic are summed by the system creating a total score for each game or event associated with each owner 14.

Block 48 then shows that System 16 creates a ranking list by sorting the games or events for each owner 14 in descending order of the total score derived in the previous step described in block 46. Thus a given owner 14 will have listed by System 16 the games or events in descending order of preference as a result of the scoring and weighting that has been done by the system. This information is then transmitted from block 48 back to block 42 which will create a final ranking list for each owner 14 based upon the owner 14's input information. System 16 will then display this ranking list to each owner 14. If desired and allowed by the rules governing group 24, each owner 14 can also see the ranking list for the other owners 14 in the group 24 of season ticket owners. One option which the system will give to each owner is to allow an owner 14 to maintain as confidential his ranking list.

Block 50 shows that each season ticket owner 14 will review his ranking list and then adjust the games or events as needed or appropriate. Typically this is done by owner 14 reconsidering the ranking that he has assigned to specific games and adjusting that ranking by “dragging-and-dropping” (or simply re-ordering) a particular game to another position on the ranking list if owner 14 has changed his mind as to the importance of that game or event. Owner 14 can also make these adjustments if the system has for some reason through the ranking system misread the games or events the owner wishes to see in a manner that appears to be contrary to the owner's wishes. Also there may be specific games or events desirable to the owner which do not meet the specific criteria set forth in the system for ranking the events or games. In this case the owner can place those events or games into the ranking list as he desires. Owner 14 could also decide to return to Block 40 to adjust the preference category weights or back to Block 36 to adjust the preference data thus forcing System 16 to recalculate the ranking list with the intent of creating a ranking list better suited to the preferences of the owner 14.

Block 52 shows that the System 16 records each user's input.

Block 54 shows that owner 14 then reviews the options for the draft such as a “LiveDraft” or an “AutoDraft”, surrounding consecutive games or events, and any other preferences related to the drafting, or selecting, of games or events. Selecting the LiveDraft options allows an owner 14 to select his own games while AutoDraft instructs System 16 to select the games or events on behalf of the owner 14. The consecutive games or events options allow the owner to either request or refuse consecutive games. This is particularly important if the owner 14 has a desire to see a particular baseball team, for example, which may be playing in a series of three games consecutively. This owner 14 may desire to attend one of the series of games but not all three. The consecutive games options will allow an owner 14 to determine how many games to select in the series. Each season ticket owner 14, if he desires, can also mark special characteristics for each game as shown in block 56. Such special characteristics might be that the game or event is very desirable and the owner may permit its selection as a consecutive game while other games or events in the season adhere to more stringent selection rules.

Block 58 then shows that system 16 records the user input, informs the user when the ranking preferences and drafting preferences process is complete and thereby informs each owner 14 that he is ready for the draft.

FIG. 2c shows in block 60 that the System 16 begins the draft at a time specified by the primary season ticket owner 12.

As shown in block 62, System 16 detects to see which season ticket owners 14 are drafting using the live draft and which season ticket owners 14 are drafting using the autodraft. The use of the autodraft basically substitutes the logic and algorithms of the system in System 16 for the individual being present during the drafting operation.

Block 64 shows that System 16 receives the draft order and begins the draft (i.e. the allocation of tickets for games) with the first picker from owner group 24 in the first draft. The draft continues following the ranking of the owners with each owner having one choice each round of the draft until all games or events have been selected. The sequence in which each owner 14 gets to choose games or events can vary depending upon a number of factors. As described below, for example, the sequence can be such that the first owner in the first round of picking will be the last owner entitled to pick in the second round of picking. In this case, the middle owner will always be in the middle and then the owner who is second to pick in the first round will become next-to-last to pick in the second round and so on. Other algorithms can also be used such as randomly assigning selection rights or any other appropriate method of selection which can be agreed upon by the owners in group 24.

FIG. 2d shows the process by which decisions are made by software in System 16. As shown in block 66, System 16 begins the selection process for a season ticket owner 14 who is using the autodraft function. The autodraft function basically replaces an owner 14 who does not desire to attend in person the draft with a selection process created by the system of this invention.

The System 16, as shown in block 68, in each round of the draft locates the remaining game or event that is ranked highest on a ranking list of the season ticket owner 14 using the autodraft function. The game or event so-located is the current pick for that owner 14. Next in block 70 decision 1 is made. As shown in the Decision Detail Table, decision 1 determines whether the season ticket owner 14 who is using the autodraft function wants to prevent picking consecutive games. If “yes”, then the system automatically goes to block 72 representing decision 2. Decision 2 asks whether based on the parameters defined by the season ticket owner 14 using the autodraft, the current pick is a consecutive game. If the answer is “yes”, then block 74 incorporating decision 3 comes into play. Decision 3 asks has the current pick been marked by season ticket owner 14 as a game or event that is permitted to be selected as a consecutive game or event. If “yes”, then the system goes to block 86 which allows System 16 to select the current pick.

Returning to block 70 decision 1, if the season ticket owner does not want to prevent picking consecutive games, the system automatically goes to System 16 to select the current pick. Returning to block 72 if the decision 2 is such that the current pick is not a consecutive game, then the system automatically again goes to System 16 shown in block 86 to select the current pick. If decision 3 shown in block 74 is a “no”, then the system goes to block 76 and System 16 to locate the next pick which is the remaining game or event that is ranked next highest on the ranking list after the current pick of the season ticket owner 14 using the autodraft function.

The system then goes to block 78 where decision 4 must be made. Decision 4 involves the system determining based on the parameters defined by the season ticket owner 14 if the next pick is a consecutive game. If the answer is “yes”, then the system goes to block 80, which involves decision 5. Decision 5 asks whether the next pick has been marked by season ticket owner 14 as a game or event that is permitted to be selected as a consecutive game or event. If the answer is “no”, then the system loops back to block 76 to go to next pick and loop until this condition is a “yes”.

If the answer is a “yes”, then block 82 is invoked to involve decision 6. Decision 6 asks if the season ticket owner 14 has set a preference to prevent all consecutive games or events only if the next pick is ranked lower than the current pick by a factor set as a preference by the season ticket owner 14. If the answer is to prevent all consecutive games or events, then the system goes to System 16 to select the next pick. If the answer is that the season ticket owner 14 has limited consecutive games or events based on ranking comparison, then the system goes to block 84 and decision 7.

Decision 7 asks if the current pick is ranked higher than the next pick by a limit set by season ticker owner 14. If the answer is “yes”, then the system automatically goes to System 16 and selects the current pick. If the answer is “no”, then the system goes to System 16 and selects the next pick. In either event, the block 90 is next invoked to cause System 16 to record the selection, remove the game or event selected from all ranking lists and then go on to the next picker.

Returning for a moment to block 78, if decision 4 is that the season ticket owner 14 would be picking a consecutive game based on the parameters defined by season ticket owner 14 and the answer is a “no”, then the system automatically goes to block 82 and decision 6 which again has recorded whether the season ticket owner 14 set a preference to prevent all consecutive games or events or to prevent consecutive games or events only if the next pick is rated lower than the current pick by a factor set as a preference by the owner 14.

FIG. 2e describes the,process by which System 16 notifies season ticket owner 14 who is participating in the live draft that it is his turn to select the game. A person who is a season ticket owner 14 must make a selection within the time allowed or a selection will be made by the System 16 based on the preferences and ranking set by that owner 14. Block 92 shows this step. Block 94 shows the System 16 making recommendations by displaying top ranked games or events and flagging such games or events as consecutive to games or events previously selected.

Block 96 then asks if the owner 14 participating in the live draft has made the selection within the allowed time. If “yes”, then block 100 shows that the season ticket owner 14 has entered the selection of the game or event and block 102 shows that the System 16 records the selection and removes the game or event selected from all rankings and then goes on to the next picker. Returning to block 96 if the selection was not made within the time allowed, then block 98 shows that System 16 makes the selection by following the process outlined in FIG. 2d in the same manner as though owner 14 was participating in the autodraft.

FIG. 2f shows the process in accordance with this invention by which System 16 operates following the completion of administering the draft of games or events as all games or events have been selected. Block 104 is the initiation of this sequence of steps following the selection of all games or events.

Block 106 shows that System 16 notified all season ticket owners 14 that the draft is complete and results are immediately available.

System 16 in block 108 then sends an email or equivalent to all members of the season ticket group 24 (FIG. 1) stating that the draft is complete and displaying the results for all owners as well as individual results for each owner and stating that the results are available on the group web-site.

Block 110 shows that, the System 16 then displays the complete draft results and makes options available for each game or event. Block 112 deals with one option. In particular season ticket owner 14 can offer to trade tickets to a game or event to another season ticket owner 14 in the season ticket membership group 24. Under block 114 if the trade offer is accepted then in block 116 System 16 updates the database to show that the trade transaction has taken place.

Another sequence of events is shown by block 118 where owner 14 can offer to purchase or sell tickets to a game or event to another season ticker owner 14 in the season ticket membership group 24. Block 120 asks if the purchase or sale offer has been accepted. If the purchase or sale offer has been accepted by another owner 14 in the membership group 24, then as shown in block 122, System 16 updates the database to show that a purchase-sale transaction has taken place and identifies the seller and the buyer.

Another sequence of events can occur as shown in block 124. Owner 14 can assign or give a ticket to a game or event to another season ticker owner 14 in the season ticket membership group 24 or to any other person.

When this is done, block 126 has the season ticket owner 14 notifying the assignee using the System 16's split-season-ticket service.

System 16, as shown in block 128, updates the database to show that an assignment has taken place. The person acquiring a ticket can be identified.

Consequently, the person receiving the assignment will be registered in the split-season-ticket System 16 and if the ticket is going to be fulfilled electronically (for example, printed at home), that person's name and other identifying information such as address, perhaps even driver's license number or email address, will be also printed on the ticket for verification purposes. Of course assignment can also involve the mere mailing of ticket to the person to whom the tickets have been assigned.

An alternative transaction that can be implemented by System 16 involves the season ticket owner 14 selling, purchasing, trading or assigning a ticket to a third party outside of the group 24 of which owner 14 is a member. Block 130 (FIG. 2f) shows such an owner conducting such a transaction.

System 16 under these circumstances as shown in block 132 will facilitate the transaction with the third party. Two options are available here. As shown in block 136 season ticket seller 18 (FIG. 1) can in fact conduct the transaction. And under these circumstances the season ticket seller 18 can identify the purchaser and then can provide the essential information to the owner 14 who is selling, trading or assigning the ticket to a person outside of group 24.

Alternatively, as shown in block 134, System 16 can communicate with a third party ticket vendor or the market place such as eBay to conduct a transaction thereby selling the ticket of owner 14. All such possible implementations are contemplated by the disclosed systems and methods.

Block 138 shows that any tickets for games or events within the schematic diagram 10 can be fulfilled electronically by exchanging data with the seller 18.

In some embodiments of the invention, the system of FIG. 1 can be implemented as a series of screen displays, such as from a computer-based user interface. Such interfaces are programmed to allow users to enter information outlining their preferences for tickets. System 16 then captures that information and uses it to calculate a ranked list of tickets for each season ticket owner 14 that is specific to that owner's preferences.

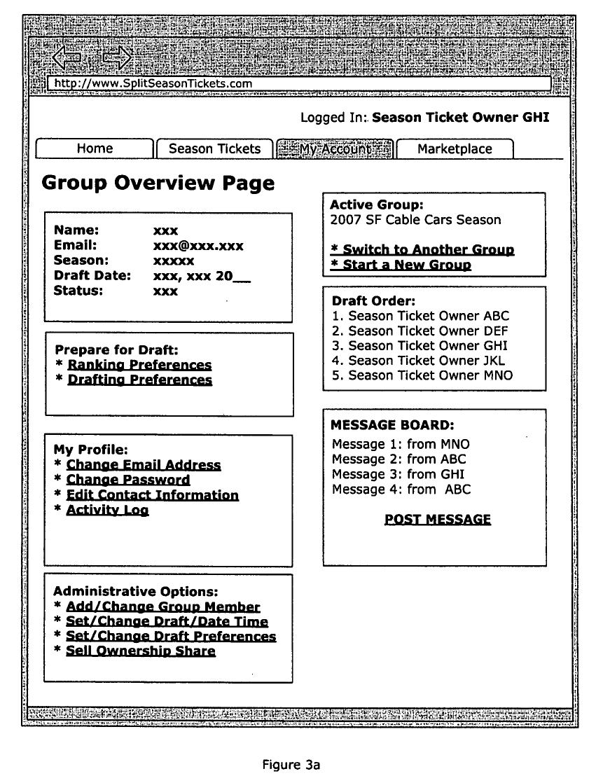

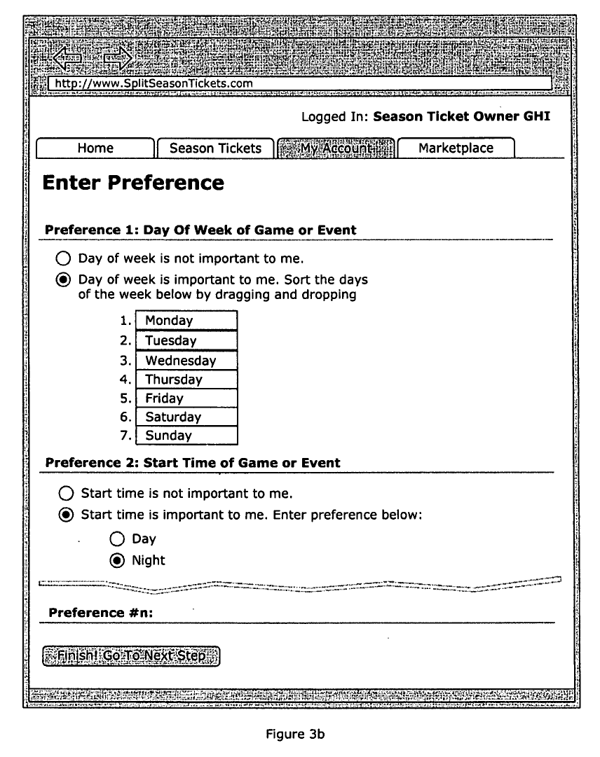

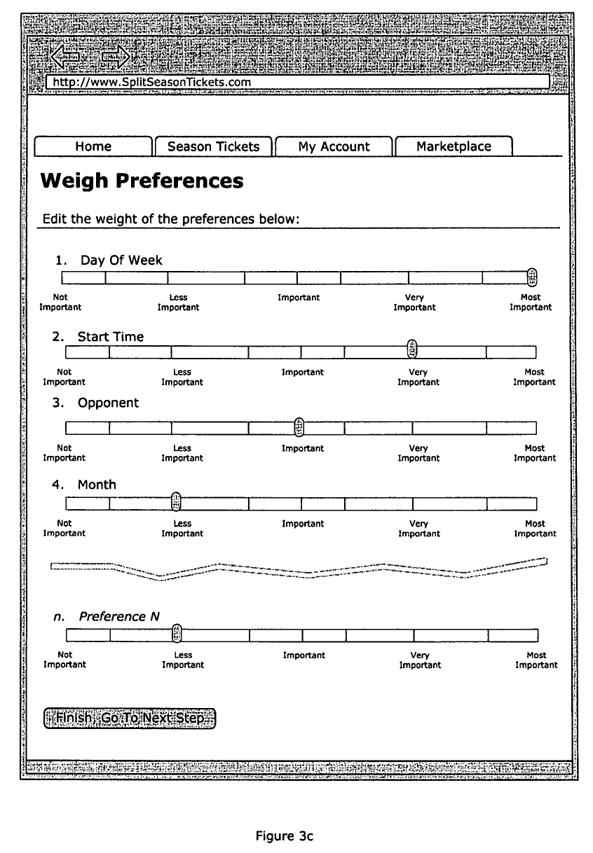

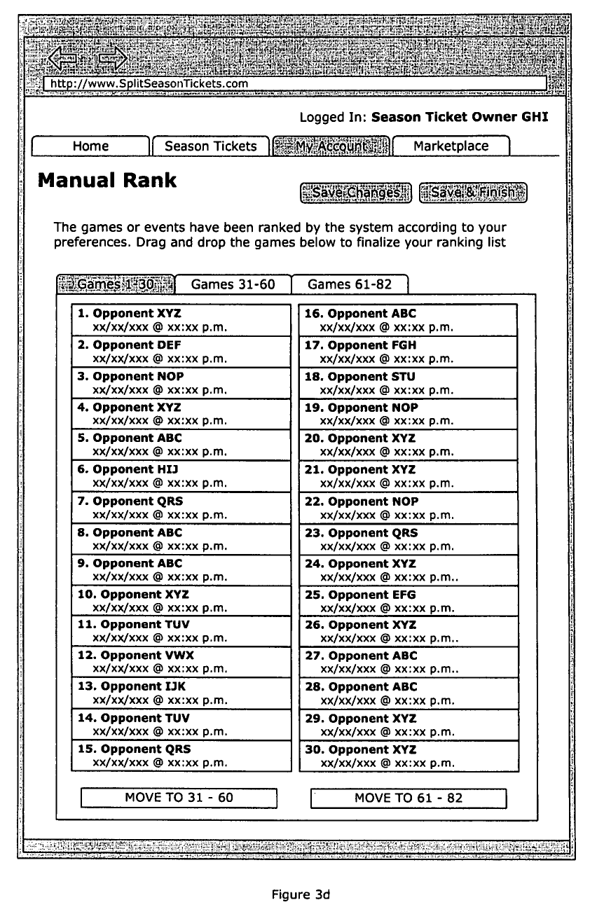

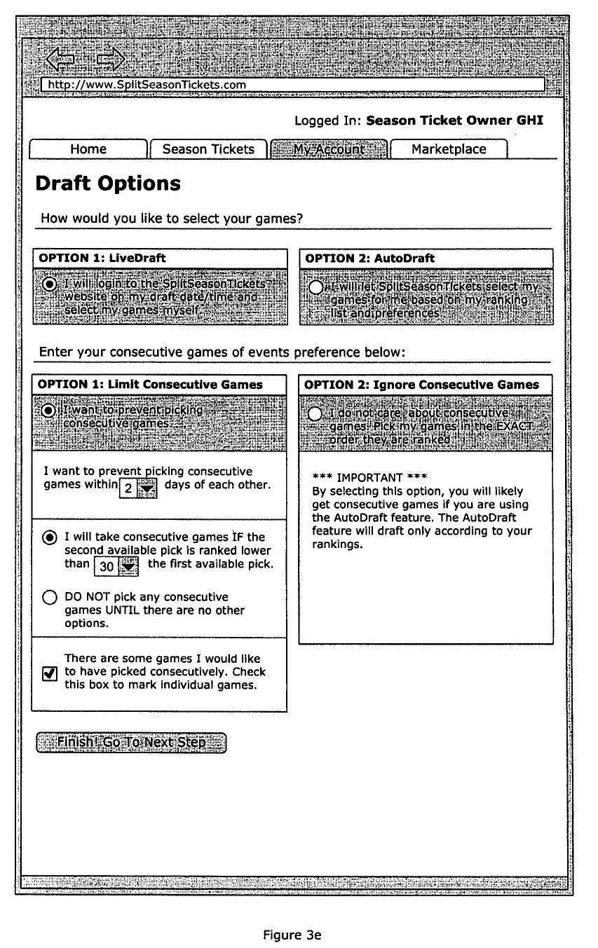

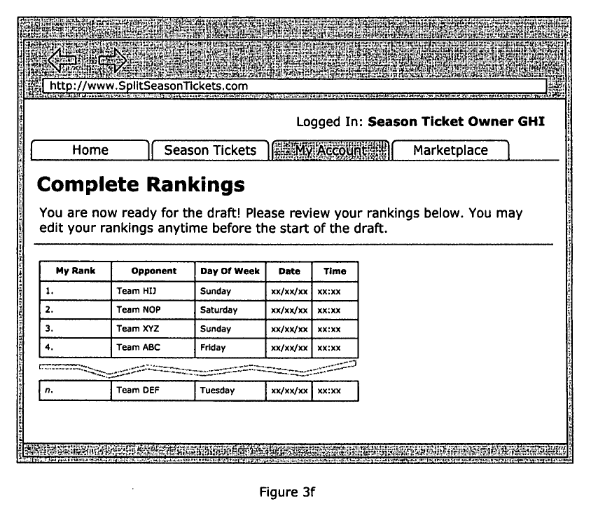

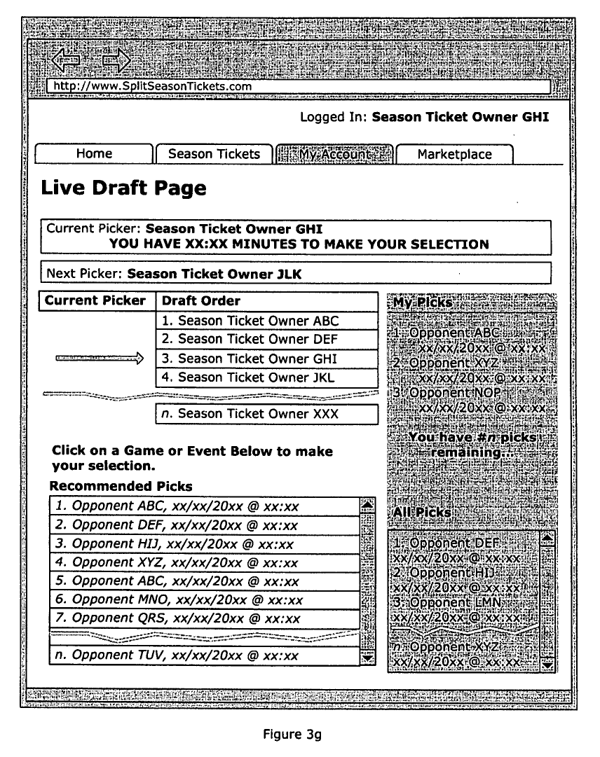

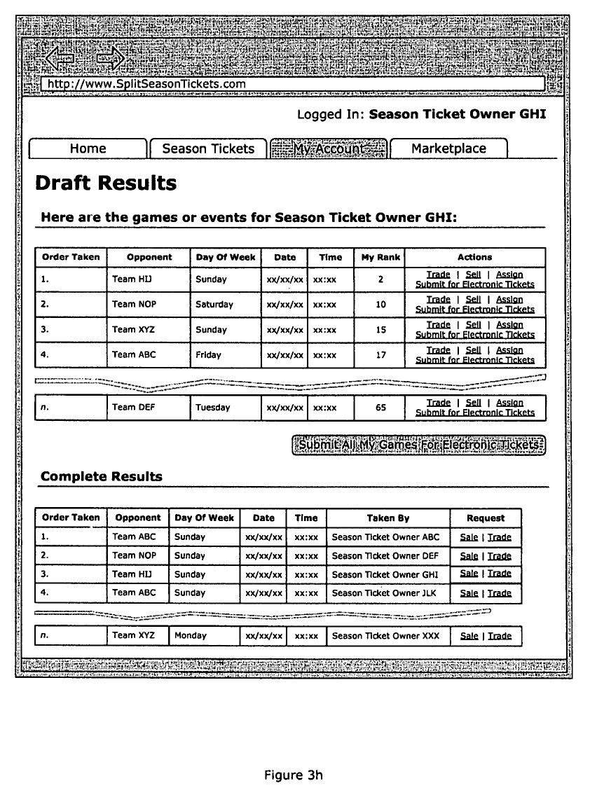

From the Group Overview Page FIG. 3a, every season ticket owner 14 has access to the “SET RANKING PREFERENCES” and the “SET DRAFTING PREFERENCES” processes and can see all of the relevant group information (group name, draft date, all owners in the season ticket ownership group 24, and draft order (i.e. the order in which each of the owners 12 and 14 will be able to exercise their selections) as well as an email/internet message board system for communicating with the season ticket ownership group 24.

Upon beginning the ranking process, System 16 presents to every owner 14 the first of a series of “web pages” used in the ranking process. The first page, Enter Preference Page FIG. 3b, gives each season ticket owner 14 the ability to enter his preferences for games or events for the season. For example, season ticket owner 14 can declare that certain days of the week or start times for games or events are preferable to him. Other categories of preferences can include, but are not limited to, opponents played, promotional gifts at a specific game or event, and months during which games or events are to take place. Owner 14 will have a list of preferences that are relevant to the season and will be able to enter specific information for each preference as well as be able to declare whether a preference is or is not important to him.

Upon completion of Enter Preference Page FIG. 3b, System 16 records all of the data entered by each season ticket owner 14 and presents each season ticket owner 14 with the Weigh Preferences Page FIG. 3c. The Weigh Preferences Page FIG. 3c allows each season ticket owner 14 to assign weight to the preference categories. Each preference is given a weight on a sliding scale ranging from “MOST IMPORTANT” to “NOT IMPORTANT”.

Upon completion of Weigh Preferences Page FIG. 3c, System 16 records all of the data entered by each season ticket owner 14. System 16 takes all of the preference data and preference weighting data for each owner 14 and calculates a priority ranking list of all of the games or events in the season. System 16 reviews each of the characteristics of each game or event and compares the characteristics to preferences and weights entered by each season ticket owner 14. Each game or event is given a score by taking the data entered by the owner 14 and (1) multiplying the numerical ranking given to each characteristic by the numerical weighting given to the specific category of that characteristic leading to a score for each characteristic, and (2) then adding up the scores of all the characteristics. Games or events are ranked by score from highest total score to lowest total score by the System 16. The ranked list of games or events is presented to the season ticket owner 14 in descending order on the Manual Ranking Page FIG. 3d.

### EXAMPLE NO. 1

A group 24 (FIG.1) of two season ticket owners 14 share season tickets to the Los Angeles Bakers, a basketball team with games on Fridays and Saturdays only in the summer months. Each game has two relevant characteristics (Month and Day of Week) for which each season tickets owner 14 must enter preferences in the first step of the ranking process: 1) Month and 2) Day of Week. (See FIGS. 3b and 3c). The first season ticket owner 14 ranks his preferences for Month (June, July, August) and then for Day of Week (Friday, Saturday). The second season ticket owner 14 ranks his preferences for Month (August, July, June) and Day of Week (Saturday, Friday). System 16 assigns values between 1 and 0 to the preferences entered in this step. The top ranked preference gets the highest value equal or close to 1 and the lowest ranked preference gets a value equal or close to 0.

On the next web page (FIG. 3c) and the second step of the ranking process, the season ticket owners 14 must weigh the preference categories on a sliding scale from the highest to lowest: Most Important, Very Important, Important, Less Important, Not Important). The first season ticket owner 14 enters Most Important for Month and Less Important for Day of Week. The second season ticket owner 14 ranks Month Not Important and Day of Week Most Important. System 16 assigns a multiplier between 1 and 0 for the preference rankings given in step two. On a sliding scale, Most Important will get a value equal or close to 1 and Not Important will get a value equal or close to 0.

For each game, System 16 reviews the two relevant characteristics specific to that game, and multiplies the scores assigned by each season ticket owner 14 in steps one and two of the ranking process and the sums the scores for each characteristic. Consequently, each game or event gets a total score. Games or events are ranked in descending order from highest to lowest to create a ranking list.

To continue this example, the first season ticket owner 14 will have a ranking list generated by System 16 that has games in June and Friday at the top of the list. The second season ticket owner 14 will have a ranking list generated by System 16 that has games on Saturday at the top of the list and then games on Friday as Month was set as Not Important in the second step. For example, the first owner 14 prefers games on Fridays and games in June. The first owner gave weights of “Most Important” to month and “Less Important” to Day of Week. Consequently, the highest ranked games for this owner 14 would be calculated by the following formula:

$$( Month Preference Detail \vert Score \text{:} Saturday \vert 1 ) \times ( multiplied by ) ( Month Weight Detail \vert Score \text{:} Most Important \vert 1 ) ) + ( Plus ) ( ( Day of Week Preference Detail \vert Score \text{:} June \vert 1 ) \times ( multiplied by ) ( Day of Week Weight Detail \vert Score \text{:} Less Important \vert 0.25 ) ) = ( equals ) 1.25 = ( 1 + 0.25 )$$

Scores for each game are calculated the same way. For the first owner 14, a game on Friday in July would have a score of 0.75 because the Month characteristic is July and therefore has a lower Month Preference Detail Score (July|0.5) while the Day of Week, Friday, remains the same as the above example and therefore receives the same score (0.25).

### END EXAMPLE NO. 1

It is possible that the two or more owner 14 can have games or events ranked the same. In other words, they want to attend the same game or event. In this case, the draft order determined by the group 24 resolves the conflict. If two owners 14 desire the same game, the owner 14 who picks first is the one who would get to select the game

On the Manual Ranking Page FIG. 3d, the season ticket owner 14 has the ability to view the rankings generated by the System 16 and also to fine-tune the ranking of his games or events. Owner 14 can easily change the rankings by “dragging-and-dropping” individual games or events into different positions. Upon any change made by season ticket owner 14, the entire ranking list is updated by System 16.

Upon completion of the Manual Ranking Page FIG. 3d, System 16 records all of the ranking changes made by season ticket owner 14. On the next page, Draft Options Page FIG. 3e, season ticket owner 14 is able to declare whether he wants to draft his games using the LiveDraft functionality or the AutoDraft functionality. He is further able to refine his selection of games or events by anticipating the potential selection of games or events that are chronologically consecutive. For example, two games or events may be very similar in their characteristics and may be occurring within a short time period of each other, but season ticket owner 14 may want to only attend one of the games or events and not both. Draft Options Page FIG. 3e allows owner 14 the option of picking consecutive games or preventing or limiting the selection of consecutive games or events. Should owner 14 wish to be more specific with his preferences on picking consecutive games or events, system 16 makes the option available to allow owner 14 to set preferences for individual games or events or groups of games or events.

Upon completion of the Draft Options Page FIG. 3e, season ticket owner 14 has completed the “Set Ranking Preferences” and the “Set Drafting Preferences” processes and is now ready for the draft. Each owner 14 has the ability to edit his ranking or drafting preferences at any time before the start of the draft.

The draft order is the order in which each season ticket owner 14 of the season ticket ownership group 24 makes his selection of games or events during the draft. Typically, season ticket ownership group 24 will pick first to last and then the opposite direction last to first. In this case, the season ticket owner 14 in last position will get the last pick of the first round, and the first pick of the second round. The season ticket owner 14 in first position will get the first pick in the first round, the last pick in the second round, and the first pick in the third round. Every season ticket owner 14 in the season ticket ownership group 24 gets one pick per round. Of course other algorithms can be used to determine the order in which the owners 14 get to pick their choices in each round. For example, the owner 14 in first position for the first round can be rotated to second position for the second round with the owner 14 in last position in the first round being shifted to first position for the second round and then to the second position for the third round and so on for each round. If the number of owners 14 equal the number of events covered by the season tickets so that each owner attends only one event in the season, then a different algorithm can be used such as drawing lots to see which owner 14 gets the first pick. That owner 14 would, of course, no longer be entitled to any picks and the remaining owners would draw lots to see which of the remaining owners 14 get the next pick and so on until the last owner 14 is left with the only unpicked event.

During the draft, System 16 will follow the draft order (for example, established by selections and preferences made by PST owner 12) and accept a pick from each season ticket owner 14 in the season ticket ownership group 24 in each round and will continue to have rounds until all of the games or events have been selected.

As discussed above, the date and time for the season ticket ownership group 24 draft is typically set by PST owner 12. Each season ticket owner 14 has the option to (1) let System 16 select games or events on his behalf based on his draft ranking and preferences; or (2) attend a live draft by connecting to System 16 via a communication network, such as the internet, before the predetermined start date and time, and make the actual selections himself.

A season ticket owner 14 who decides to let System 16 select games or events on his behalf does not need to attend the draft in any capacity. When it is this Season Ticket Owner 14's turn to select a game or event, System 16 will go through the following steps:

(1) select highest ranked remaining game or event;

(2) if the Season Ticket Owner 14 has preferences to prevent or limit consecutive games, check the highest remaining game or event against previously selected games or events, and if the highest ranked remaining game or event conflicts with consecutive games or events preferences, then go through further steps to select the game or event that best matches the preferences and rankings of Season Ticket Owner 14;

(3) select game or event on behalf of Season Ticket Owner 14;

(4) record the result;

(5) make the game or event just selected no longer available to anyone in the season ticket ownership group 24; and

(6) proceed to the next picker.

A season ticket owner 14, who decides to attend a “live draft”, must connect to System 16 via a communication network, such as the internet, before the predetermined start date and time. When it is this season ticket owner 14's turn to select a game or event, System 16 will review all of the remaining games or events for season ticket owner 14 and provide recommendations to season ticket owner 14 based on his rankings and preferences. System 16 will prompt season ticket owner 14 to select a game or event. Season ticket owner 14 will have a predetermined amount of time (the amount of time allowed is a preference that can be set by PST Owner 12) to make a selection. If owner 14 does not make his selection in the predetermined amount of time, System 16 can follow the procedure outlined in the paragraph above and make the selection on behalf of season ticket owner 14. If owner 14 makes his selection in the allotted amount of time, the result is recorded, the game or event is no longer available, and the system proceeds to the next picker (i.e. owner 14).

Once all of the games or events in the season have been selected, the draft is complete. All season ticket owners 14 who attended the “live draft” are told by the System 16 that the draft is over and the full results are immediately emailed (or equivalent) to all members of season ticket ownership group 24. In addition to an email (or equivalent) with results, season ticket owner 14 can access System 16 and view the Draft Results Page FIG. 3h. On the Draft Results Page FIG. 3h, the following will be available:

(1) all games or events selected by each individual season ticket owner 14 with all of the relevant details for each game or event;

(2) all games and events selected by all members of the season ticket ownership group 24;

(3) options to TRADE, SELL, BUY, ASSIGN/GIVE, any of the tickets for the individual games or events belonging to an individual season ticket owner 14; and

(4) an option to download the data for an individual season ticket owner 14 in a data format of his choosing (comma delimited file, Microsoft Outlook file, Palm Desktop file, or other common format, for example) for the purpose of exporting the game or event data into the personal calendaring system of their choice; and

(5) ticket fulfillment options for any tickets for the individual games or events belonging to an individual season ticket owner 14. By integrating with seller 18, System 16 can facilitate ticket fulfillment physically (by mail, delivery, pick-up) or electronically (print at home, cell phone, venue kiosk, or other methods).

The season ticket seller 18 will be able to access the information gathered and contained in System 16. Software associated with the present invention allows for integration of the information in System 16 with one or more systems owned by season ticket seller 18. Season ticket seller 18 is the actual business or company (for example a professional sport team, a college sports team or an entertainment business) that is responsible for the games or events for which the season tickets are issued. Season ticket seller 18 will be able to load data regarding its games or events into the System 16. For example, to promote use of the schematic diagram 10, seller 18 could load user information about season ticket owners so that their registration and purchase process with System 16 is more efficient

### EXAMPLE NO 2

A group of two season ticket owners 14 share season tickets to the Los Angeles Bakers, a basketball team and the seller 18 of the season tickets in an implementation of schematic diagram 10 (FIG. 1). In this example, seller 18 is integrated with System 16 and seller 18 and System 16 interact in the following ways:

1) Seller 18 pays for and encourages season ticket owners 14 to use System 16 because System 16, is more efficient, saves time and money, and provides marketing and revenue-generating opportunities for seller 18.

2) When seller 18 pays for the services provided by System 16, seller 18 transmits data via API (discussed earlier) about seller 18's season ticket owners 14 and the tickets they own to System 16. System 16 receives the data and grants access to, creates group websites for, and notifies, season ticket owners 14. This saves the season ticket owners 14 in each group 24 the time and hassle of having to initiate and complete the purchase and configuration of their website for their group 24. Possessing this data also allows System 16 to create actual tickets which grant admission to the stadium for specific games or events. Of importance, in accordance with the disclosed embodiments, the tickets can be electronic thereby to avoid the hassle and expense of sending actual tickets to each season ticket holder 14, or paper in which case the paper tickets will either be held at “will call”, mailed to each season ticket holder 14, or otherwise made available to each season ticket holder 14.

3) Once the drafting process is complete, season ticket owners 14 can submit their games to seller 18 for electronic ticketing. Seller 18 prefers to save money by not printing and mailing physical tickets and instead, receives the games, ticket, and ownership information from System 16 and fulfills the tickets electronically. This electronic fulfillment can happen several ways, but may include, and is not limited to, printing tickets at home, transmitting tickets to a cellular phone or portable device, transmitting tickets to a stadium kiosk tied to a personal identifier like a credit card or email address/password, or leaving tickets in “will call”.

4) Once the drafting process is complete, a season ticket owner 14 can sell his tickets on the website belonging to seller 18. Without physical tickets the transaction is easily completed. The new buyer of the tickets can have his tickets fulfilled electronically as described above.

5) Once the drafting process is complete, a season ticket owner 14 can assign or give one or more of his tickets to another person. This assignment can happen through System 16 and a personal identifier such as an email address or cell phone number. The assignee receives notification of the assignment or gift via System 16 and can then receive electronic fulfillment of the tickets from seller 18.

6) If seller 18 chooses not to use electronic fulfillment, he will receive the ticket and ownership information from System 16 and distribute actual physical tickets to each season ticket owner 14 using traditional mail, delivery, pick-up, or will-call at the game or event venue.

7) Seller 18 receives valuable marketing data not limited to: name, contact information, ticket transaction information, and game or event preference data, which were previously unknown to seller 18. This marketing data has high value to seller 18.

### END EXAMPLE NO. 2

Schematic diagram 10 (FIG. 1) is also useful for the issuing of the actual tickets to the owners 14. By accessing data held in System 16, seller 18 could distribute tickets more efficiently because seller 18 will know specifically which season ticket owner 14 owns which tickets. Physical tickets could be mailed to directly to each season ticket owner 14 in group 24 instead of mailing them to PST owner 12 for him to distribute owners 14. Further, schematic diagram 10 makes electronic tickets more likely to be accepted for general use as schematic diagram 10 provides more accurate data on ownership of the tickets and provides a forum where tickets can easily be traded, bought, sold, and assigned or transferred. Season ticket seller 18 will also benefit from data gathered by System 16 concerning the identity and contact information of more season ticket owners as well as their preferences.

System 16 shall have the capacity to TRADE, SELL, BUY, ASSIGN, GIVE or TRANSFER tickets to individual games or events between members of the season ticket ownership group 24. From within the System 16, an owner 14 can perform the following functions related to transferring of tickets:

(1) request a trade for ticket(s) with another member of the ownership group;

(2) offer to sell or buy ticket(s) to or from another member of the ownership group;

(3) assign or give ticket(s) to another member of the ownership group; and

(4) assign or give ticket(s) to a person not a member of the ownership group.

The capability of System 16 to host computer-based transactions, and any associated user interfaces, is known.

### EXAMPLE NO. 3

Five friends, (Larry, George, Henry, Steve, and Ted) have shared season tickets to the San Francisco Cable Cars, a major league baseball team located in San Francisco, Calif., for the past ten years. Every year they have the same four seats and get four tickets for every home game. Larry has been in charge of the seats since they first purchased the season tickets and therefore he is the only one who communicates with the San Francisco Cable Cars for the purchase of the season tickets and he is the one who coordinates the purchase, the collection of money, the division of games between the five friends, as well as the distribution of the actual tickets. In order to divide the seats amongst the five friends, Larry coordinates a meeting in which all five friends meet and have a draft where they each select games in sequence (following a draft order created at random by drawing straws) and in rounds until all of the games have been selected. Each round alternates in order going first to last and then last to first to ensure a fair distribution of games. After the draft, Larry is responsible for receiving the physical tickets to all of the games, sorting them out by which friend selected which game, and then delivering the tickets in person or via mail to each friend.

This year the friends have agreed to use the Split-season-tickets service to select and manage their games. As Larry has been the leader of the group, he accesses the Split-season-tickets service via a computer and the Internet, and signs up for the service for the current year and upcoming season for the San Francisco Cable Cars. The service entitles Larry to add the rest of the group to the service and for the entire group to be able to use the service to rank and select their games in a draft and then manage their games once the selection process is complete. After signing up for the service, Larry enters key group data such as the draft date, the draft order (could be selected randomly by the service or entered manually by Larry), the group name, and any other group preferences. Larry then enters the names and email addresses of his four friends, George, Henry, Steve, and Ted. The Split-season-tickets service then sends an email to everyone in the group with an explanation of the service and detailed instructions on how to access the service.

Each of the five friends (including Larry, as he is an owner of the ticket as well in addition to being the administrator for the group), receives the email and registers and enters the Split-season-tickets website via a computer and the Internet. Upon entering the Split-season-tickets website, each of the friends sees an overview page that contains the key group information such as draft date and draft order. Each friend must complete the ranking process for the games any time before the start of the draft.

To begin the ranking process, each friend clicks on a link. The first step in the process is to “Enter Preferences”. In this step the friends are presented with four preferences specific to the season for which they are season ticket owners. In this case, for the San Francisco Cable Cars, the friends must enter their preferences for:

(1) Days on which games are played;

(2) Months in which games are played;

(3) Times at which games start; and

(4) Opponent for the games.

For each of the four preferences above, each friend must enter and rank his preference. For Days on which games are played, George, for example, will select the Day that is an important preference to him and will rank the days as follows: Saturday, Sunday, Friday, Wednesday, Thursday, Tuesday, and Monday. Henry may also select that Days on which games are played is important as well, but rank the days differently as follows reflecting his preferences: Wednesday, Tuesday, Monday, Sunday, Saturday, and Thursday. Days on which games are played does not matter to Steve so he selects that option (i.e. that Days are not important) and would not then have to rank the days of the week.

For Months in which games are played, the friends must decide whether the preference is important to them and, if so, they must rank the months. Ted, for example, has children and therefore prefers the summer months and would rank the months as follows: June, July August, September, May, April.

Times at which games start is another preference for this season. To use Ted again, since he has children he states that this preference is important to him and he will select game start times in the day rather than the evenings so his children can attend the games as well.

Lastly, each of the friends decides whether the opponent for each game is a preference that is important to them. If yes, each friend selects that the preference is important to him and then must rank the opponents. Larry is originally from New York, so he will rank the New York Bets and the New York Lankees baseballs teams the highest and then he will fill in the rest. Henry likes to watch the Los Angeles Podgers and the other teams in the San Francisco Cable Cars' division play so he ranks the Los Angeles Podgers the highest, then the San Diego Cadres, then the Colorado Mountains, and so on. The rest of the friends rank the opponents according to their preferences.

The next step in the process is to weigh each preference in relation to each other. Ted, and his obligation to his children, would rank Month in which games are played as the most important preference, then time in which games start (to ensure his children get to see day games), then days on which games are played, and finally opponent.

Larry really cares most about seeing teams from New York and therefore he makes Opponents have the most weight. Larry also likes games on weekends so Days on which games are played also gets high weight. In the same fashion, the other three friends give weight to the preferences according to what they want.

Once each friend has completed the two ranking steps, the Split-season-tickets service takes their preference data and creates a ranking list of the games in the season. The ranking list is calculated by assigning a score to each game. The higher the score, the more desirable the game is to the particular friend. Each game score is calculated by breaking out each of the game's pertinent characteristics (in this case: (1) day of the week, (2) month, (3) game start time, and (4) opponent), and giving each of the characteristics a score based on the data entered in the first step. Using Ted again, a game in June would get the highest score in the month preference while a game in April would get the lowest. Then, the score for each characteristic would be multiplied by the preference weight given in step two of the process. Each of the four pertinent characteristics for each game would get scored in this manner and then summed to yield a total score for each game. The Split-season-tickets service would sort the games in descending order by total score and present them to the friend.

Unless two friends entered the identical data in the first two steps, each friend will get a different ranking list generated by the Split-season-tickets service. This is expected as every individual will likely have different preferences. The third step in the ranking process asks each friend to review his ranking list generated by the system and then fine tune the ranking to be sure that his ranking list is exactly what he wants it to be. Larry, for example, ranked the teams from New York as his highest games, and, expectantly, the games with New York teams as the opponent are the highest on his system-generated ranking list. However, Larry has a wedding that he must attend on the date of one of the New York Bets games and therefore would not be able to attend the game should it be selected for him. In this case, Larry would “drag-and-drop” the game that he cannot attend to a lower position in his ranking list. Based on what he entered in steps one and two, Ted's ranking list will feature games in the summer months and games during the day. There may be a few games at the top of the ranking list that Ted's family cannot attend so Ted would “drag-and-drop” those games to a lower position in his ranking list. In both instances, moving games lower or higher in the list changes the entire ranking list and refines the ranking list further to better reflect the individual's preferences for the games they desire.

After finalizing the ranking list manually, each friend needs to define his Drafting Options. First each friend must decide whether he wants to use the LiveDraft feature or the AutoDraft feature. Then he also has the option to restrict consecutive games. This is significant as certain friends may not want to go to two games in two days and prefer to spread out their games somewhat. Steve sells most of his tickets so he does not care about consecutive games and therefore selects the option to not consider consecutive games when making or recommending a selection for him during the draft. Ted, however, again has his family concerns and does not want to have consecutive games within three (3) days of each other. Ted would enter his preferences accordingly. Larry wants to prevent picking games within two (2) days of each other. The two remaining friends would set their preferences according to their own desires and needs. Each friend has the option to mark specific games that he would accept as consecutive games in a separate step. This step would be relevant to Larry being the fan of the New York teams. He will set his overall preference to avoid picking games within two (2) days of each other, but then he will manually flag all of the New York games to ignore the consecutive game preference and pick those games according to his ranking list.

Now that the games have been ranked and the preferences set, each of the friends is ready for the draft. Each friend has the option to return through the process at any time before the draft to change his rankings and preferences. George, for example, found out two days before the draft about a business trip that conflicts with one of his games on top of his ranking list. George went into the manual ranking page and moved the conflict game lower down on his list.

As stated, the draft has two options: (1) a “Live Draft” where a friend accesses the Split-season-tickets service before the start of the draft and selects the game himself, or (2) an “Autodraft” where the system selects the games for the friend based on his ranking list and preferences. The Live Draft benefits the friend who feels most comfortable selecting his own games, while the Autodraft requires absolutely no time commitment other than entering the preference and ranking data at some point before the draft.

The Split-season-tickets service sends email reminders to the friends prior to the draft. At the start of the draft, the service checks to see which friends have logged in and are using the Live Draft and which friends are using the Autodraft. The Split-season-tickets service gets the draft order and begins taking selections (via Live Draft or Autodraft) from each friend in each round until all of the games have been selected.

Larry, Ted, and George are using the Live Draft feature. They each access the service using a computer connected to the Internet. When it is their turn to pick, Split-season-tickets services notifies them that it is their turn and gives them recommendations on games to pick based on the preferences and rankings they have entered and the games that are still available. Larry, Ted, and George review the recommendations from the system, and make their selections themselves at each turn. It is important to note that each of them has a time limit to make his selection. If he does not make his selection in the given time (the amount of time is a group preference that Larry can change), then the Split-season-tickets service makes the selection on his behalf.

Steve and Henry are busy and do not want to participate in the Live Draft. They use the Autodraft functionality. They need only go through the preference and ranking steps discussed above at some, point before the draft to enable the system to select games on their behalf. During the draft, the service determines the best game for Steve and the best games for Henry at each turn.

As soon as the draft is completed, the complete results are available on the website and are emailed to each friend. Now that the games have been divided, each of the friends “owns” his individual tickets to his games and can use the system to manage his tickets. Here is what each of the friends does with his tickets.

Larry wants to keep most of his tickets. There are a couple of tickets that he cannot use so he uses Split-season-tickets service to offer to trade tickets with George and with Ted. George accepts the trade and Split-season-tickets service records the transaction. Ted does not accept the trade and the Split-season-tickets service notifies Larry of the rejected offer. That leaves Larry with tickets for one game that he cannot use. Larry decides to use the Split-season-tickets service to offer the remaining tickets that he cannot use for re-sale. Split-season-tickets service brokers the transaction with a partner ticket vendor on behalf of Larry. Once Larry has completed all of his transactions, he can submit his tickets to the San Francisco Cable Cars for “e-ticketing”. The data for all of the tickets that Larry owns will be sent from Split-season-tickets service to the San Francisco Cable Cars. The San Francisco Cable Cars will accept the data, record the ownership of the tickets and then transfer electronic tickets to Larry. Electronic tickets will have proper security technology and can be in the form of “print-at-home” tickets, cell phone tickets, stadium kiosk tickets, or other.

Ted is going to use most of his tickets, but he cannot use tickets for five of his games. Ted chooses to not sell the tickets, but instead to assign (give) them to friends and clients. Ted can assign ownership of tickets to games by using the Split-season-tickets service to indicate which tickets and games go to which people. Ted uses a unique identifier, such as email address, instant messenger ID, or mobile phone number, to identify the assignee of the tickets. Split-season-tickets service notifies the assignee of the tickets and authenticates them. Once Ted has assigned all of his “extra” tickets, he submits the tickets to the San Francisco Cable Cars for electronic ticketing. In this instance, all of the tickets that have been assigned are also submitted for electronic ticketing. Ted and all of the assignees receive electronic tickets from the San Francisco Cable Cars.

Steve does not go to any of his games but instead sells or assigns his tickets. Steve uses the Split-season-tickets service to connect to ticket vendors to resell his tickets. The tickets that he does not sell, he assigns to friends and clients. Steve can submit some of his tickets to the San Francisco Cable Cars for electronic ticketing, but other he cannot and must get physical tickets.

Henry is an avid fan and attends all of his games. He submits all of his tickets to the San Francisco Cable Cars for electronic ticketing.

George goes to most of his games but sells two tickets to three different games using the Split-season-tickets service to facilitate the transaction with a third party vendor.

During the season, the friends have the all of the options to sell, trade, assign tickets within the group and to people outside the group.

If the San Francisco Cable Cars have a successful season and make the post-season and playoffs, Split-season-tickets service allows for a second in-season draft for those additional tickets to the additional games. Larry, the group administrator sets the drafting and preference options for those additional games and each of the friends follows the similar process described above to rank, select, and manage these additional tickets.

After the season, Split-season-tickets service keeps in touch with the friends to provide relevant news and remind them to renew their service for the next season.

### END EXAMPLE NO. 3

### EXAMPLE NO. 4

### Acme Corporation Season Tickets to Los Angeles Bakers

Acme Corporation purchases season tickets to the Los Angeles Bakers, a basketball team in the National Basketball Association. The Executives get first pick of the games, and the rest of the games are divided amongst the sales, marketing, accounting, human resources, and support departments. John Smith, the CEO, signs up for the service, as described in example 1. The difference this time however, is that the CEO picks fifteen games out of the season that the executives want to attend. The remaining games are entered into the ranking and drafting system described in example 1. Each of the heads of the departments goes through the drafting process and then distributes his tickets. When the tickets get distributed, they can be submitted to the Los Angeles Bakers for electronic ticketing.

### END EXAMPLE NO. 4

### EXAMPLE NO. 5

### The San Jose Whales Ticket Sales Department

The San Jose Whales, a hockey team belonging to the National Hockey League based in San Jose, have a season ticket sales department that desires to sell more season tickets. They encourage potential season ticket purchasers who cannot afford or do not wish to purchase an entire season to register on Split-season-tickets service and enter their preferences and rankings. The Split-season-tickets service will match these potential purchasers with other potential purchasers for the purpose of forming groups to purchase season tickets. The Split-season-tickets service matches potential purchasers by matching potential purchasers whose rankings and preferences ARE DISSIMILAR, so that they can go to more games that are desirable to them. Once the groups are formed, they purchase season tickets from the San Jose Whales sales department, and then follow the process outlined in example 1.

While various systems and methods have been described in terms of season tickets, the invention is not so limited. Rather, various embodiments of the invention can be employed to divide up many different types of items. One of ordinary skill in the art will realize that the invention can be utilized to allocate any items that are capable of allocation according to user-expressed preferences. Furthermore, various embodiments of the invention can employ any one or more of the features described above. For example, some systems can include the ability to host an automated draft, a live draft, or both. Other systems may include the ability to transfer tickets between a group of season ticket holders and members of the public or members of other groups

### END EXAMPLE NO. 5

### EXAMPLE NO. 6

### Administrator Options

As discussed, the primary season ticket owner 12 (FIG.1) serves as the administrator for the season ticket ownership group 24. Below are some examples of the functions the primary season ticket owner 12 can perform:

1) primary season ticket owner 12 can add, edit, or delete each of the season ticket owners 14 who belong to the season ticket ownership group 24. Primary season ticket owner 12 enters the email address and name of each owner 14 (including the name and address of the primary season ticket owner 12) into System 16.

2) Primary season ticket owner 12 can edit the ownership percentage of each owner 12. For example, a group consisting of four owners 14 (as explained above, primary season ticket owner 12 is also an owner 14) can have three owners 14 with 20% each of the ownership and one owner 14 with 40% of the ownership. The games or events would be drafted according to ownership percentages. In this case, each round of the draft would have five picks with the 20% owners 14 having one pick each per round and the 40% owner 14 having two picks per round.

3) Primary season ticket owner 12 can select games or events to be in a draft. For example, a group 24 may desire to draft half of a season's games before the start of the season and the remaining half of the season's games after the season has begun. Primary season ticket owner 12 can determine which games are drafted in which draft.

4) Primary season ticket owner 12 can enter and edit the date and time of a draft.

5) Primary season ticket owner 12 can designate ownership of certain games or events. Primary season ticket owner 12 may have the authority to remove games or events from the draft and assign ownership for those games or events. For example, primary season ticket owner 12 may be the boss of a company and consequently desires to remove ten games which he chooses to attend leaving the remaining games to be drafted by the owners 14 in the group 24. The owners 14 in this case might be, for example, department heads of the company).

6) Primary season ticket owner 12 can initiate additional drafts as needed.

For example, a sports team may make the playoff meaning more games would be added to a season. Primary season ticket owner 12 could create a new draft for these additional games.

7) Primary season ticket owner 12 can change ownership of games or events on behalf of owners 14. This function needs to be within the authority of primary season ticket owner 12. An activity log is kept for all actions to prevent any abuse of power. An example of a use of this function could occur if there are not enough games or events in the final round for every owner 14 to receive a pick. The group may decide to have these remaining game(s) chosen at random or on a rotating basis, or by any method they choose. Primary season ticket owner 12 could change ownership of specific tickets after the draft to reflect the wishes of the group 24.

8) Primary season ticket owner 12 can set and edit the draft order. Primary season ticket owner 12 has an option to pick the order at random, or primary season ticket owner 12 can enter and edit the order manually.

9) Primary season ticket owner 12 can initiate and transact a sale of a percentage of ownership in the season ticket group 24 to a third party outside group 24 using the systems of System 16. This action would need to be within the authority of the primary season ticket owner 12.

10) Primary season ticket owner 12 can set privacy settings to allow or disallow the viewing by members of the group 24 of the rankings of games or events based on the preference data of the other owners 14. Other preferences settings could include but are not limited to: group name, group icon, group color.

### END EXAMPLE NO. 6

While a number of embodiments have been described, other embodiments will be obvious to those skilled in the relevant arts in view of the above disclosure.

What is claimed is:

1. A system which comprises:
means for allowing one or more season ticket owners to select and purchase or acquire a service for a season of games or events for which the one or more season ticket owners own season tickets to allow each of the one or more season ticket owners to be assigned a subset of the season tickets in accordance with preferences set by each of said one or more season ticket owners; and
means for allowing each of said one or more season ticket owners to manage their tickets for a given season using a server and website.

2. The system as in claim 1 including
means for allowing said one or more season ticket owners who have purchased the service to add additional owners to the service;
means for allowing each of said one or more season ticket owners to set the preferences for the group (such as group name, draft date, group preferences, draft order); and
means for allowing the system to communicate with all members of the group using an email and internet posting function provided by the system.

3. The system as in claim 1 including
means for allowing each season ticket owner to view all of his, her or its options for a given season;
means for allowing each season ticket owner to enter a set of preferences related to the characteristics of the games or events in a season for which the season tickets have been issued; and
means for allowing the season ticket owners to rank those preferences.

4. The system of claim 1 further comprising:
means for receiving the preference input and preference rankings from each of the season ticket owners; and,
means, using a weighted system of points based on the one or more season ticket owners' inputs, for generating a ranked list of games or events for each season ticket owner.

5. The system of claim 1 further comprising:
means for allowing each season ticket owner to view the ranked list of games or events generated by the system for that owner; and
means for allowing each season ticket owner to fine-tune that owner's ranking by dragging-and-dropping individual games or events to allow the season ticket owner to generate the precise game or event ranking the season ticket owner desires.

6. The system of claim 1 further comprising:
means for allowing each season ticket owner to enter preferences regarding consecutive games or events.

7. The system of claim 1 further comprising:
means for allowing each season ticket owner to have the option to identify specific consecutive games or events or subsets of consecutive games or events that the season ticket owner would accept being drafted.

8. The system of claim 7 further comprising:
means for allowing each season ticket owner to fine tune his or her preferences by adjusting the rankings of games or events so that the system will more accurately select the games or events desired by each season ticket owner.

9. The system as in claim 1 further comprising:
means for allowing one or more season ticket owners to set a time for the drafting of tickets for games or events by the group, wherein this means for allowing one or more season ticket owners to set a time for the drafting comprises;
means for giving to each individual season ticket owner the option of attending a “live draft” via his or her personal computer or other device connected to a communication network, such as the internet; or
means for allowing the system to select games or events for each owner using each owner's preference and ranking input.

10. The system of claim 9 further comprising:
means for allowing each season ticket owner in a group of season ticket owners to attend a live draft where any member of the group of season ticket owners can view the draft in real time; and
means for allowing the system to request a selection from an owner every time it is that owner's turn to select a game or event.

11. The system of claim 10 further comprising:
means for allowing the system to use the preference and ranking information entered by one or more season ticket owners to serve as a recommendation list from which the system will dynamically recommend games or events to be selected by that owner at every turn; and
means for automatically removing games or events previously selected by other owners from a given owner's recommendation list.

12. The system of claim 1 further comprising:
means for allowing each season ticket owner to decide to let the system draft his, her or its games or events for him, her or it by using all of the preference and ranking information entered by the season ticker owner.

13. The system of claim 12 further comprising:
means for allowing the tickets for one or more of the season ticket owners to be selected without requiring the one or more season ticket owners to attend the live draft; and
means for automatically selecting a game or event for each season ticket owner who does not attend the live draft when that season ticket owner's turn to select arises using the information as to preferences entered into the system by each such season ticket owner.

14. The system of claim 13 further comprising:
means for creating a results page on the system website so that the results of the draft for the entire group of season ticket owners in addition to individual results are available to all of the season ticket owners in the group; and
means for emailing to each season ticket owner in a group of season ticket owners the results of the draft by which tickets are assigned to each of the season ticket owners in the group upon completion of the draft.

15. The system of claim 1 further comprising:
means for allowing season ticket owners to trade, sell, buy, or assign their tickets to other owners within the group once the draft assigning subsets of the season tickets to specific season ticket owners is complete.

16. The system of claim 1 further comprising:
one or more application programming interfaces (“APIs”), that will allow the system to interact with, exchange data with, and conduct transactions with sellers of tickets for games or events; and
means for integrating this system with the systems of actual ticket sellers upon mutual consent;
thereby to benefit the season ticket owners using the system by allowing accurate data regarding the games or events for which each season ticket owner acquires tickets to be loaded into the system directly from the ticket sellers to enable a season ticket owner to replace any lost ticket and to allow the ticket sellers to provide either physical or electronic tickets to each season ticket owner.

17. The system of claim 16 further comprising:
means for allowing the purchase, sale, trade, and/or resale of tickets between various groups of season ticket owners by connecting the systems of ticket sellers to the systems of said service via the APIs.

18. The system of claim 17 further comprising:
means for providing application programming interfaces, (“APIs”), for allowing the system to be used by one or more groups of owners of one or more season tickets to interact and exchange data with ticket brokers.

19. The system of claim 18 further comprising:
APIs and software for allowing the system of the present invention to become integrated in the systems of the ticket brokers upon mutual consent;
thereby to allow a group of season ticket owners to sell unwanted tickets quickly and easily to people outside of their group.

20. A method of allocating items from within a group of items, the method comprising:
receiving first ranking numbers ranking categories of preferences associated with the items, each preference relating to a characteristic of the items;
receiving second ranking numbers ranking the preferences within the categories of preferences;
determining at least one preference order for the items according to the first ranking numbers and the second ranking numbers; and
displaying the at least one preference order for items, so as to facilitate the selection of the items from the group of items according to the at least one preference order.

21. A method of allocating season tickets among a group of users, comprising:
receiving from each user in a group of users a set of preference information, the preference information describing preferences of each user for ones of the season tickets;
for each user, ranking the season tickets according to the set of preference information, so as to generate ranked lists of the season tickets; and
presenting to each user his, her or its associated ranked list of the season tickets, so as to facilitate a selection of the season tickets by each user.

22. The method of claim 21 wherein, for each user, the ranked list is a ranking of the games or events in a season according to a correspondence of the season tickets to the preference information, the ranking including a highest-ranked game or event, the method further comprising:
(A) for each user, allowing for manual selection by the user or allowing the system to automatically select the highest-ranked game or event from the season, so as to generated selected games or events;
(B) removing the selected game or event from the ranked lists of the season tickets, so as to prevent further allocation of the selected game or event; and
repeating (A) and (B) in order until all of the games or events have been selected.
